(19) United States
(12) Patent Application Publication
(10) Pub. No.: US 2016/0269948 A1
(43) Pub. Date: Sep. 15, 2016

(54) RRC CONNECTION REESTABLISHMENT IN A WIRELESS COMMUNICATION NETWORK

(71) Applicant: TELEFONAKTIEBOLAGET L M ERICSSON (PUBL), Stockholm (SE)

(72) Inventors: Jun Wang, Nanjing (CN); Zijing Liu, Nanjing (CN); Xiaodong Yang, Nanjing (CN)

(73) Assignee: Telefonaktiebolaget LM Ericsson (publ), Stockholm (SE)

(21) Appl. No.: 15/030,833

(22) PCT Filed: Jan. 17, 2014
(86) PCT No.: PCT/CN2014/070782

§ 371 Date: Apr. 20, 2016

(51) Int. Cl. H04W 36/00; H04W 48/16; H04W 76/04

(52) U.S. Cl. CPC H04W 36/0066; H04W 76/046; H04W 36/0083; H04W 48/16

(57) ABSTRACT

Methods for facilitating Radio Resource Control (RRC) connection reestablishment between a communication device and a target communication node in a wireless communication network and the respective device and node are disclosed. The method in the communication device comprises generating a RRC connection reestablishment request message which includes a Physical Cell Identifier (PCI) of a source cell to which the communication device attaches before the RRC connection reestablishment and transmitting the RRC connection reestablishment request message to the target communication node. The communication device receives from the target communication node a first RRC connection reestablishment rejection message which includes a first indicator indicating need of first information for the RRC connection reestablishment, detects the first indicator from the first RRC connection reestablishment rejection message, generates a first communication device information response message which includes the first information and transmits the communication device information response message to the target communication node.

### TECHNICAL FIELD

The present disclosure generally relates to Radio Resource Control (RRC), and more particularly relates to methods and respective communication device or node for RRC connection reestablishment in a wireless communication network.

### BACKGROUND

With the rapid develop in wireless communication technologies, Long Term Evolution (LTE) wireless communication systems which support high speed packet-switched data transmission are being deployed in many countries. In the LTE system, RRC layers of the User Equipment (UE) and the network exchange RRC messages, as a basis for radio resource settings, for completing various RRC control procedures. For example, the UE in the RRC_IDLE state can establish RRC connection with the network through a RRC connection establishment procedure, while the UE in the RRC_CONNECTED state can reestablish a RRC connection with the network through a RRC connection reestablishment procedure. A description to the RRC protocol is given in 3GPP TS 36.331.

The object of the RRC connection reestablishment procedure is to reestablish the RRC connection, which includes restoring Signaling Radio Bearer 1 (SRB1) and reactivating the security. Scenarios in which a UE needs an RRC connection reestablishment request are defined in the 3GPP RRC protocol. For example, the RRC connection reestablishment procedure may be initiated if the UE detects that the radio link with the eNodeB (evolved NodeB) fails, the cell handover fails or an RRC connection reconfiguration fails.

In many cases, the eNodeB may need the UE to provide some extra information such as Cell Global Identity (CGI) during the RRC connection reestablishment procedure. For example, in case that the UE moves from a source cell to a target cell but unfortunately the cell handover fails, the target eNodeB can not resume the broken RRC connection without the CGI of the source cell and as a result the data service may be interrupted.

According to the 3GPP specification, the existing UE Information Response message is utilized to convey the CGI information only when the UE enters CONNECT state again. In particular, once failing in the RRC reestablishment, the UE returns back to IDLE state. Later when the UE re-initiates ATTACH procedure again, it may put the CGI information into the UE Information Response message delivered to the eNodeB even if the new ATTACH scenario is actually independent with previous handover. However, this method can be only applied to UEs staying at the CONNECT state, in other words, if the UE fails in RRC reestablishment procedure, the UE must wait until it successfully re-ATTCHes into the Evolved UMTS Terrestrial Radio Access Network (eUTRAN) again to utilize the method. As a result, there is always a time delay between the handover failure and reception of CGI. Such a time delay is completely decided by the UE itself, and could be a rather long time in some cases, such as power OFF/ON. The unpredictable and long time delay may lead to loss of real-time. It is possible that the eNodeB receiving the CGI is not the one experiencing the RRC reestablishment procedure. For example, consider the situation as shown in FIG. 1. The UE firstly moves from the source cell that is served by the eNodeB 110 into the target cell that is served by the eNodeB 120. A handover happens but unfortunately fails. The UE then moves into a third cell that is served by the eNodeB 130 before it successfully re-ATTCHes to the eUTRAN. Due to the time delay, although the CGI of the source cell (CGI=20) can be provided to the eNodeB 130, it is useless since the third cell is no longer adjacent to the source cell.

### SUMMARY

Therefore, it is an object of the present disclosure to solve one of the above-mentioned problems.

According to an aspect of the disclosure, a method for facilitating a communication device to reestablish a RRC connection with a target communication node in a wireless communication network is disclosed. The communication device generates a RRC connection reestablishment request message which includes a Physical Cell Identifier (PCI) of a source cell to which the communication device attaches before the RRC connection reestablishment and transmits the RRC connection reestablishment request message to the target communication node. The communication device receives from the target communication node a first RRC connection reestablishment rejection message which includes a first indicator indicating need of first information for the RRC connection reestablishment, detects the first indicator from the first RRC connection reestablishment rejection message, generates a first communication device information response message which includes the first information and transmits the communication device information response message to the target communication node. The first information may include a CGI of the source cell. In an embodiment, the communication device may further receive from the target communication node a second RRC connection reestablishment rejection message which includes a second indicator indicating need of second information for the RRC connection reestablishment, detect the second indicator from the second RRC connection reestablishment rejection message and generates a second communication device information response message which includes the second information and transmitting the second communication device information response message to the target communication node. The second information may include at least one of a measurement result of the source cell and a measurement result of neighbouring cells.

According to another aspect of the disclosure, a method for facilitating a target communication node to reestablish a RRC connection with a communication device is disclosed. The target communication node receives from the communication device a RRC connection reestablishment request message which includes a PCI of a source cell to which the communication device attaches before the RRC connection reestablishment, and looks up a neighbour cell list for a cell that matches the PCI. If no cell matching the PCI is found in the neighbour cell list, the target communication node generates a first RRC connection reestablishment rejection message which includes a first indicator indicating need of first information for the RRC connection reestablishment and transmits the RRC connection reestablishment rejection message to the communication device, then receives from the communication device a communication device information response message which includes the first information, obtains corresponding communication device context from a source communication node that corresponds to the source cell using the first information, and reestablishes the RRC connection with the communication device using the communication device context. In an embodiment, the target communication node may further generate a second RRC connection reestablishment rejection message which includes a second indicator indicating need of second information for the RRC connection reestablishment and transmit the second RRC connection reestablishment rejection message to the communication device, then receive from the communication device a second communication device information response message which includes the second information.

According to a further aspect of the disclosure, a communication device (510) operable to reestablish a RRC connection with a target communication node in a wireless communication network is disclosed. The communication device comprises a RRC controlling unit and a transceiver. The RRC controlling unit is adapted to generate a RRC connection reestablishment request message which includes a PCI of a source cell to which the communication device attaches before the RRC connection reestablishment. The transceiver is adapted to transmit the RRC connection reestablishment request message to the target communication node, and receive from the target communication node a first RRC connection reestablishment rejection message which includes a first indicator indicating need of first information for the RRC connection reestablishment. The RRC controlling unit is further adapted to detect the first indicator from the first RRC connection reestablishment rejection message and generate a communication device information response message which includes the first information, and the transceiver is further adapted to transmit the communication device information response message to the target communication node. In an embodiment, the transceiver may be further adapted to receive from the target communication node a second RRC connection reestablishment rejection message which includes a second indicator indicating need of second information for the RRC connection reestablishment. The RRC controlling unit may be further adapted to detect the second indicator from the second RRC connection reestablishment rejection message, and generate a second communication device information response message which includes the second information. The transceiver may be further adapted to transmit the second communication device information response message to the target communication node.

According to still a further aspect of the disclosure, a communication node operable to reestablish a RRC connection with a communication device in a wireless communication network is disclosed. The communication node comprises a transceiver and a RRC controlling unit. The transceiver is adapted to receive from the communication device a RRC connection reestablishment request message which includes a PCI of a source cell to which the communication device attaches before the RRC connection reestablishment. The RRC controlling unit is adapted to look up a neighbour cell list for a cell that matches the PCI, and if no cell matching the PCI is found in the neighbour cell list, generate a first RRC connection reestablishment rejection message which includes a first indicator indicating need of first information for the RRC connection reestablishment and transmit the first RRC connection reestablishment rejection message to the communication device. The transceiver is further adapted to receive from the communication device a communication device information response message which includes the first information, and the RRC controlling unit is further adapted to obtain corresponding communication device context from a source communication node that corresponds to the source cell using the first information and reestablish the RRC connection with the communication device using the communication device context. In an embodiment, the RRC controlling unit may be further adapted to generate a second RRC connection reestablishment rejection message which includes a second indicator indicating need of second information for the RRC connection reestablishment and transmit the second RRC connection reestablishment rejection message to the communication device, and the transceiver may be further adapted to receive from the communication device a second communication device information response message which includes the second information.

By reusing the RRC connection reestablishment rejection message and the communication device information response message during the RRC connection reestablishment, a more efficient mechanism to convey the information needed for the RRC connection reestablishment is provided. As a result, the RRC connection may be reestablished more quickly even at some abnormal cases where the existing RRC connection reestablishment might fail and impacts to the data service will be reduced. In addition, more than one RRC connection reestablishment rejection message may be sent in sequence to the communication device, notifying the communication device to provide different information. Such an on-demand information conveying mechanism is more flexible and may save signaling overhead.

### BRIEF DESCRIPTION OF THE DRAWINGS

The invention will be described in detail by reference to the following drawings, in which:

FIG. 1 illustrates an example in which the information as provided by a UE becomes useless when the UE moves from a target cell to another cell during RRC connection reestablishment;

FIG. 2 illustratively shows a signaling flow 200 of the improved RRC connection reestablishment in accordance to an embodiment of the disclosure;

FIG. 3 illustratively shows a method 300 for facilitating a communication device to reestablish a RRC connection with a target communication node in a wireless communication network in accordance with an embodiment of the disclosure;

FIG. 4 illustratively shows a method 400 for facilitating a target communication node to reestablish a RRC connection with a communication device in a wireless communication network in accordance with an embodiment of the disclosure; and

FIG. 5 illustratively shows a block diagram of the communication device 510 and the target communication node 520 involved in RRC connection reestablishment in accordance with an embodiment of the disclosure.

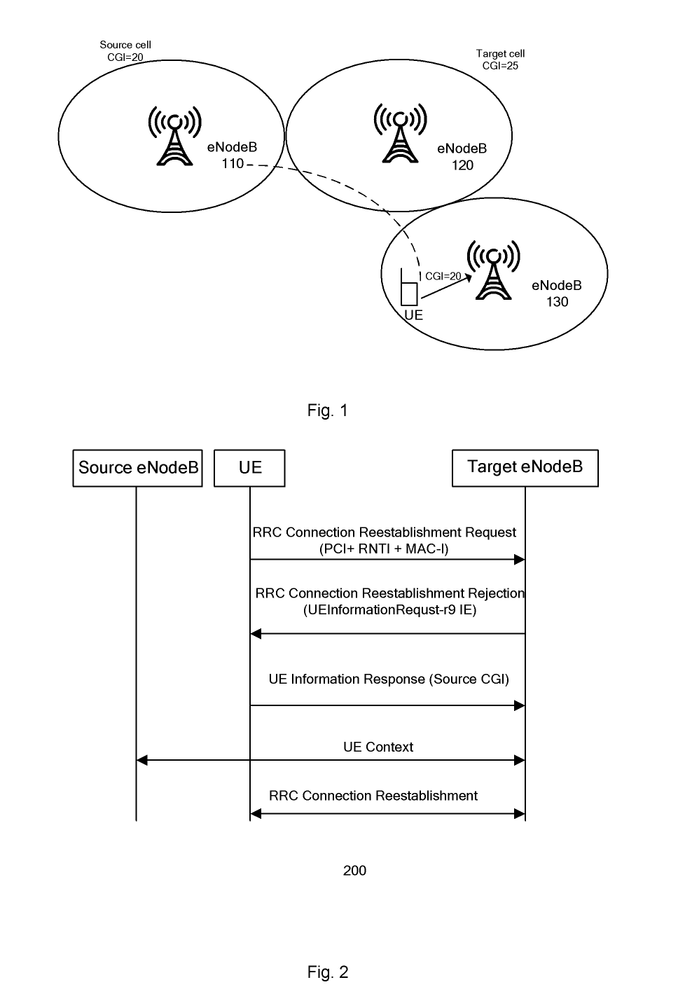

### DETAILED DESCRIPTION

Embodiments of the present disclosure will be described more fully hereinafter with reference to the accompanying drawings, in which embodiments of the disclosure are shown. This invention may, however, be embodied in many different forms and should not be construed as limited to the embodiments set forth herein. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present disclosure is described below with reference to block diagrams and/or flowchart illustrations of methods, apparatus (systems) and/or computer program products according to embodiments of the disclosure. It is understood that blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Accordingly, the present disclosure may be embodied in hardware and/or in software (including firmware, resident software, micro-code, etc.). Furthermore, the present disclosure may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

Although the disclosure is described with reference to the LTE in the context, the skilled in the art should understand that the invention is not limited to this, but can indeed be applied to all existing and future wireless communication networks that support RRC connection reestablishment. Although specific terms are used here, such as UE and eNodeB, it should be understood that the invention is not limited to those specific terms but can be applied to all similar entities.

Embodiments of the disclosure will be described below with reference to the drawings.

One approach to solve the problem is to directly append the information such as the CGI of the source cell into the RRC connection reestablishment request message which is transmitted from the UE to the eNodeB during a conventional RRC connection reestablishment. However, this may cause random access performance deterioration due to the increased size of the RRC connection reestablishment request message. The RRC connection reestablishment request message can not be segmented or concatenated and should be kept as short as possible, so the direct appending CGI into the RRC connection reestablishment request message is not feasible. Moreover, the CGI is not always indispensable in the RRC connection reestablishment procedure. When the source cell is correctly configured in the current eNodeB neighbour cell list, the PCI, which has already been contained in the existing RRC connection reestablishment request message, is sufficient for identification of X2 peer by which the target eNodeB may obtain the UE context from the source eNodeB. Unfortunately the UE is unaware of this, and has to always append the CGI into the RRC connection reestablishment request message, which will waste the signaling resource if the CGI is unnecessary for the RRC connection reestablishment.

FIG. 2 illustratively shows a signaling flow 200 of the improved RRC connection reestablishment in accordance to an embodiment of the disclosure.

In case that the scenarios initiating RRC connection reestablishment such as handover failure happens, the UE generates a standard RRC connection reestablishment request message and transmits it to the target eNodeB. In addition to the Radio Network Temporary Identities (RNTI) and MAC-I, the RRC connection reestablishment request message includes a PCI of the source cell to which the UE attaches before the RRC connection reestablishment. The target eNodeB, upon receiving the RRC connection reestablishment request message, looks up a neighbour cell list for a cell that matches the PCI as included in the RRC connection reestablishment request message. If there is a cell matching the PCI in the neighbour cell list, it shows that the source cell and the target cell are adjacent and the UE context is available to the target cell. In this case, the

UE and the target cell may simply follow the conventional RRC connection reestablishment procedure. If no cell matching the PCI is found in the neighbour cell list, the target UE generates a first RRC connection reestablishment rejection message and transmits it to the UE. The first RRC connection reestablishment rejection message may include a first indicator indicating need of first information such as CGI for the RRC connection reestablishment. For example, a UEInformationRequest Information Element (IE) may be introduced into the first RRC connection reestablishment rejection message to indicate that the target eNodeB needs the UE to provide the first information of its source cell. Upon receiving the first RRC connection reestablishment rejection message, the UE detects the first indicator and then realizes that the target eNodeB needs the first information of the source cell. The UE then generates a first UE information response message which includes the first information such as CGI and transmits it to the target eNodeB. The target eNodeB receives the first UE information response message, and obtains corresponding UE context from the source eNodeB that corresponds to the source cell using the first information. In particular, the target eNodeB may set up an X2 connection with the source eNodeB to obtain the UE context. The procedure of set up the X2 connection is defined by the 3GPP specification and will not be discussed in detail. With the UE context, the target eNodeB can reestablish the RRC connection with the UE following the conventional RRC connection reestablishment procedure, which will not be discussed in detail. The broken RRC connection thus can be resumed.

In addition, the above information notification mechanism may be repeated to provide other information as needed for the RRC connection reestablishment. For example, the target eNodeB may need second information, such as a measurement result of the source cell and/or a measurement result of neighbouring cells. The target eNodeB generates a second RRC connection reestablishment rejection message which includes a second indicator indicating need of second information and transmits it to the UE. Upon receiving the second RRC connection reestablishment rejection message, the UE detects the second indicator, generates a second UE information response message which includes the second information and transmits it to the target eNodeB. The eNodeB may use the information notification mechanism twice or more until all information as needed for the RRC connection reestablishment are obtained.

The proposed mechanism adds information notification functionality into the RRC reestablishment procedure, which is more efficient and predictable as compared with the approach that uses the ATTACH procedure to convey information. The RRC connection recovery time can be greatly shortened. In addition, the information is provided on demand, which is more flexible and can reduce the signaling cost. Moreover, the RRC connection reestablishment request message is not modified, and a new IE is added to the RRC connection reestablishment rejection message and the UE information response message is introduced to the RRC reestablishment procedure. The modification to the specification is minimized. UEs are backward compatible since they may simply ignore the new IE in the RRC connection reestablishment rejection message and conduct the conventional RRC reestablishment procedure.

In addition to handover failure recovery, the proposed mechanism may be applied to other scenarios, such as Automatic Neighbour Recovery (ANR), Mobility Robustness Optimization (MRO) wrong target processing and PCI confliction detection.

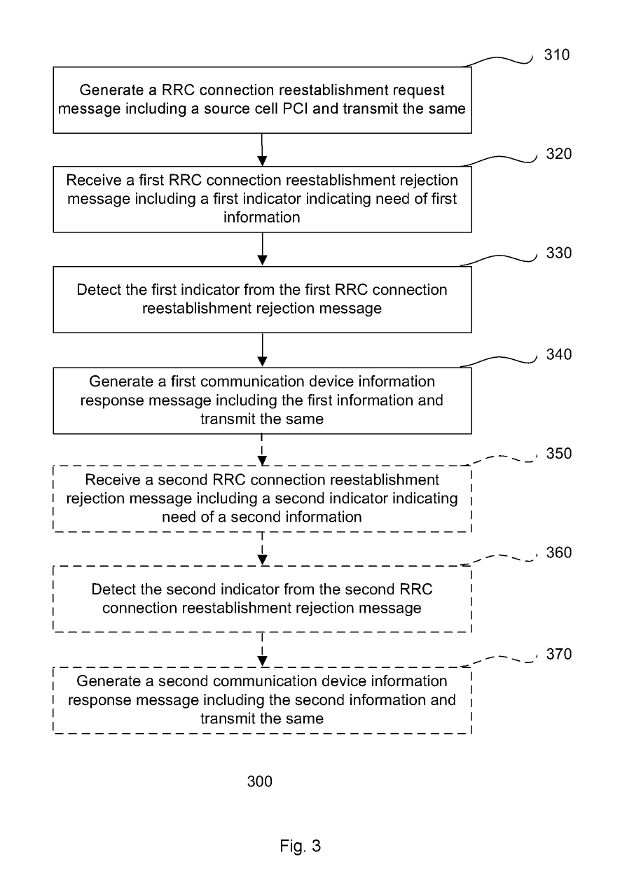

FIG. 3 illustratively shows a method 300 for facilitating a communication device to reestablish a RRC connection with a target communication node in a wireless communication network in accordance with an embodiment of the disclosure.

At step 310, the communication device, such as UE, generates a RRC connection reestablishment request message which includes a PCI of a source cell to which the communication device attaches before the RRC connection reestablishment and transmits the RRC connection reestablishment request message to the target communication node, such as the target eNodeB. At step 320, the communication device receives from the target communication node a first RRC connection reestablishment rejection message which includes a first indicator indicating need of first information for the RRC connection reestablishment. The first information may include a CGI of the source cell. The communication device detects at step 330 the first indicator from the first RRC connection reestablishment rejection message. At step 340, the communication device generates a first communication device information response message which includes the first information and transmits the communication device information response message to the target communication node. In an optional embodiment, the communication device may further receive at step 350 from the target communication node a second RRC connection reestablishment rejection message which includes a second indicator indicating need of second information for the RRC connection reestablishment. The second information may include at least one of a measurement result of the source cell and a measurement result of neighbouring cells. The communication device may detect at step 360 the second indicator from the second RRC connection reestablishment rejection message. At step 370, the communication device may generate a second communication device information response message which includes the second information and transmit the second communication device information response message to the target communication node.

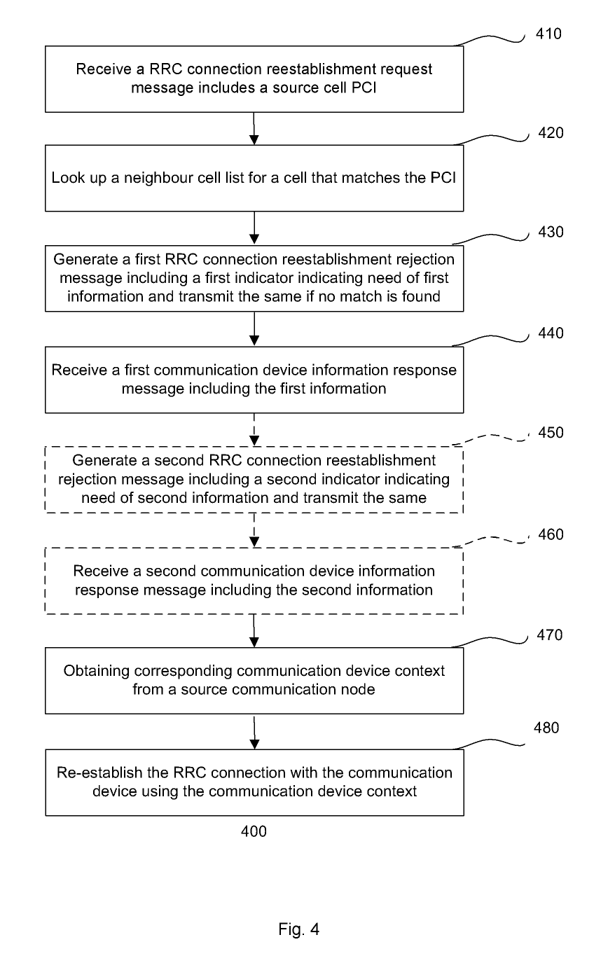

FIG. 4 illustratively shows a method 400 for facilitating a target communication node to reestablish a RRC connection with a communication device in a wireless communication network in accordance with an embodiment of the disclosure.

At step 410, the target communication node receives from the communication device a RRC connection reestablishment request message which includes a PCI of a source cell to which the communication device attaches before the RRC connection reestablishment. At step 420, the target communication node looks up a neighbour cell list for a cell that matches the PCI. At step 430, if no cell matching the PCI is found in the neighbour cell list, the target communication node generates a first RRC connection reestablishment rejection message which includes a first indicator indicating need of first information for the RRC connection reestablishment and transmits the RRC connection reestablishment rejection message to the communication device. At step 440, the target communication node receives from the communication device a communication device information response message which includes the first information. In an optional embodiment, the target communication node may generate a second RRC connection reestablishment rejection message which includes a second indicator indicating need of second information for the RRC connection reestablishment and transmit the second RRC connection reestablishment rejection message to the communication device at step 450, and receive from the communication device a second communication device information response message which includes the second information ate step 460. At step 470, the target communication node obtains corresponding communication device context from a source communication node that corresponds to the source cell using the first information (or plus the second information). At step 480, the target communication node reestablishes the RRC connection with the communication device using the communication device context.

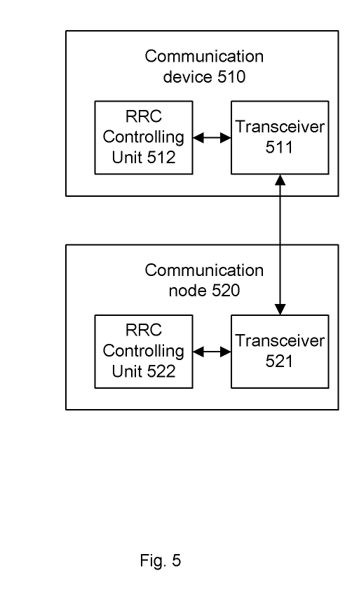

FIG. 5 illustratively shows a block diagram of the communication device 510 and the target communication node 520 involved in RRC connection reestablishment in accordance with an embodiment of the disclosure.

The communication device comprises a RRC controlling unit 512 and a transceiver 511. The RRC controlling unit 512 is adapted to generate a RRC connection reestablishment request message which includes a PCI of a source cell to which the communication device 510 attaches before the RRC connection reestablishment. The transceiver 511 is adapted to transmit the RRC connection reestablishment request message to the target communication node 520, and receive from the target communication node 520 a first RRC connection reestablishment rejection message which includes a first indicator indicating need of first information for the RRC connection reestablishment. The RRC controlling unit 512 is further adapted to detect the first indicator from the first RRC connection reestablishment rejection message and generate a communication device information response message which includes the first information. The transceiver 511 is further adapted to transmit the communication device information response message to the target communication node 520. The transceiver 511 may be further adapted to receive from the target communication node 520 a second RRC connection reestablishment rejection message which includes a second indicator indicating need of second information for the RRC connection reestablishment. The RRC controlling unit 512 may be further adapted to detect the second indicator from the second RRC connection reestablishment rejection message, and generate a second communication device information response message which includes the second information. The transceiver 511 may be further adapted to transmit the second communication device information response message to the target communication node 520.

The communication node 520 comprises a transceiver 521 and a RRC controlling unit 522. The transceiver 521 is adapted to receive from the communication device 510 a RRC connection reestablishment request message which includes a PCI of a source cell to which the communication device 510 attaches before the RRC connection reestablishment. The RRC controlling unit 522 is adapted to look up a neighbour cell list for a cell that matches the PCI, and if no cell matching the PCI is found in the neighbour cell list, generate a first RRC connection reestablishment rejection message which includes a first indicator indicating need of first information for the RRC connection reestablishment and transmit the first RRC connection reestablishment rejection message to the communication device 510. The transceiver 521 is further adapted to receive from the communication device 510 a communication device information response message which includes the first information, and the RRC controlling unit 522 is further adapted to obtain corresponding communication device context from a source communication node that corresponds to the source cell using the first information and reestablish the RRC connection with the communication device 510 using the communication device context. The RRC controlling unit 522 may be further adapted to generate a second RRC connection reestablishment rejection message which includes a second indicator indicating need of second information for the RRC connection reestablishment and transmit the second RRC connection reestablishment rejection message to the communication device 510, and the transceiver 521 may be further adapted to receive from the communication device 510 a second communication device information response message which includes the second information.

It should be noted that components in the communication node and communication device may be implemented by software or hardware or the combination thereof. For example, the RRC controlling unit may comprise a processing unit, which may be provided on a single chip or a chip module and which may be any processor or computer device that performs operations based on program codes or instructions stored in a memory. Program codes are fetched from the memory and loaded into the processing unit in order to perform the steps described in connection with FIGS. 3 and 4. The RRC controlling unit may share the same processing unit or memory with the node or device, or use separate hardware.

While the exemplary embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from its central scope. Therefore it is intended that the present invention is not be limited to the particular embodiment disclosed as the best mode contemplated for carrying out the present invention, but that the present invention include all embodiments falling within the scope of the appended claims.

1. A method for facilitating a communication device to reestablish a Radio Resource Control (RRC) connection with a target communication node in a wireless communication network, the method comprising:
generating a RRC connection reestablishment request message which includes a Physical Cell Identifier (PCI) of a source cell to which the communication device attaches before the RRC connection reestablishment and transmitting the RRC connection reestablishment request message to the target communication node;
receiving from the target communication node a first RRC connection reestablishment rejection message which includes a first indicator indicating need of first information for the RRC connection reestablishment;
detecting the first indicator from the first RRC connection reestablishment rejection message; and
generating a first communication device information response message which includes the first information and transmitting the communication device information response message to the target communication node.

2. The method of claim 1, wherein the first information includes a Cell Global Identifier (CGI) of the source cell.

3. The method of claim 1, further comprising:
receiving from the target communication node a second RRC connection reestablishment rejection message which includes a second indicator indicating need of second information for the RRC connection reestablishment;
detecting the second indicator from the second RRC connection reestablishment rejection message; and
generating a second communication device information response message which includes the second information and transmitting the second communication device information response message to the target communication node.

4. The method of claim 3, wherein the second information includes at least one of a measurement result of the source cell and a measurement result of neighbouring cells.

5. A method for facilitating a target communication node to reestablish a Radio Resource Control (RRC) connection with a communication device in a wireless communication network, the method comprising:
receiving from the communication device a RRC connection reestablishment request message which includes a Physical Cell Identifier (PCI) of a source cell to which the communication device attaches before the RRC connection reestablishment;
looking up a neighbour cell list for a cell that matches the PCI;
if no cell matching the PCI is found in the neighbour cell list, generating a first RRC connection reestablishment rejection message which includes a first indicator indicating need of first information for the RRC connection reestablishment and transmitting the RRC connection reestablishment rejection message to the communication device;
receiving from the communication device a communication device information response message which includes the first information;
obtaining corresponding communication device context from a source communication node that corresponds to the source cell using the first information; and
reestablishing the RRC connection with the communication device using the communication device context.

6. The method of claim 5, wherein the first information includes a Cell Global Identifier (CGI) of the source cell.

7. The method of claim 5, further comprising:
generating a second RRC connection reestablishment rejection message which includes a second indicator indicating need of second information for the RRC connection reestablishment and transmitting the second RRC connection reestablishment rejection message to the communication device; and
receiving from the communication device a second communication device information response message which includes the second information.

8. The method of claim 7, wherein the second information includes at least one of a measurement result of the source cell and a measurement result of neighbouring cells.

9. A communication device operable to reestablish a Radio Resource Control (RRC) connection with a target communication node in a wireless communication network, the communication device comprising:
a RRC controlling unit adapted to generate a RRC connection reestablishment request message which includes a Physical Cell Identifier (PCI) of a source cell to which the communication device attaches before the RRC connection reestablishment; and
a transceiver adapted to transmit the RRC connection reestablishment request message to the target communication node, and receive from the target communication node a first RRC connection reestablishment rejection message which includes a first indicator indicating need of first information for the RRC connection reestablishment,
wherein the RRC controlling unit is further adapted to detect the first indicator from the first RRC connection reestablishment rejection message and generate a communication device information response message which includes the first information, and
the transceiver is further adapted to transmit the communication device information response message to the target communication node.

10. The communication device of claim 9, wherein the first information includes a Cell Global Identifier (CGI) of the source cell.

11. The communication device of claim 9, wherein the transceiver is further adapted to receive from the target communication node a second RRC connection reestablishment rejection message which includes a second indicator indicating need of second information for the RRC connection reestablishment,
the RRC controlling unit is further adapted to detect the second indicator from the second RRC connection reestablishment rejection message, and generate a second communication device information response message which includes the second information, and
the transceiver is further adapted to transmit the second communication device information response message to the target communication node.

12. The communication device of claim 9, wherein the second information includes at least one of a measurement result of the source cell and a measurement result of neighbouring cells.

13. A communication node operable to reestablish a Radio Resource Control (RRC) connection with a communication device in a wireless communication network, the communication node comprising:
a transceiver adapted to receive from the communication device a RRC connection reestablishment request message which includes a Physical Cell Identifier (PCI) of a source cell to which the communication device attaches before the RRC connection reestablishment; and
a RRC controlling unit adapted to look up a neighbour cell list for a cell that matches the PCI, and if no cell matching the PCI is found in the neighbour cell list, generate a first RRC connection reestablishment rejection message which includes a first indicator indicating need of first information for the RRC connection reestablishment and transmit the first RRC connection reestablishment rejection message to the communication device,
wherein the transceiver is further adapted to receive from the communication device a communication device information response message which includes the first information, and the RRC controlling unit is further adapted to obtain corresponding communication device context from a source communication node that corresponds to the source cell using the first information and reestablish the RRC connection with the communication device using the communication device context.

14. The communication node of claim 13, wherein the first information includes a Cell Global Identifier (CGI) of the source cell.

15. The communication node of claim 13, wherein the RRC controlling unit is further adapted to generate a second RRC connection reestablishment rejection message which includes a second indicator indicating need of second information for the RRC connection reestablishment and transmit the second RRC connection reestablishment rejection message to the communication device, and
the transceiver is further adapted to receive from the communication device a second communication device information response message which includes the second information.

16. The communication node of claim 15, wherein the second information includes at least one of a measurement result of the source cell and a measurement result of neighbouring cells.
